(19) United States
(12) Patent Application Publication
(10) Pub. No.: US 2013/0019225 A1
(43) Pub. Date: Jan. 17, 2013

(54) Incremental Inferences for Developing Data Models

(71) Applicants: Andrew PETERS, Sammamish, WA (US); Arthur VICKERS, Redmond, WA (US); Diego VEGA, Sammamish, WA (US); Rowan MILLER, Kirkland, WA (US); Jeff DERSTADT, Sammamish, WA (US)

(72) Inventors: Andrew PETERS, Sammamish, WA (US); Arthur VICKERS, Redmond, WA (US); Diego VEGA, Sammamish, WA (US); Rowan MILLER, Kirkland, WA (US); Jeff DERSTADT, Sammamish, WA (US)

(73) Assignee: MICROSOFT CORPORATION, Redmond, WA (US)

(21) Appl. No.: 13/179,629

(22) Filed: Jul. 11, 2011

(51) Int. Cl. G06F 9/44; G06F 17/30

(52) U.S. Cl. 717/106; 717/121

(57) ABSTRACT

An application programming interface may alter the inferences made by a set of conventions that may infer database objects from memory objects in an application. The changes or overrides to the inferences may be applied when the application is executed and may cause the database objects to be created or organized in a different manner than when the original inferences were used. A configuration database may store the inferences and overrides, and may be referenced when the conventions are applied. The configuration database may be incrementally updated so that any changes or overrides are persisted to the next version of an application.

### CROSS REFERENCE TO RELATED APPLICATIONS

This application is related to the following applications: U.S. patent application Ser. No. 13/166,825 filed 23 Jun. 2011 entitled “Conventions for Inferring Data Models” and having attorney docket number 332804.01, as well as the following applications co-filed with the present application: U.S. patent application Ser. No. ______ entitled “Translating CLR Patterns into Database Schema Patterns” and having attorney docket number 333198.01, U.S. patent application Ser. No. ______ entitled “Object-Relational Mapped Database Initialization” and having attorney docket number 333497.01, U.S. patent application Ser. No. ______ entitled “Fluent API Patterns for Managing Object Persistence” and having attorney docket number 333498.01.

### BACKGROUND

Many computer applications use a combination of databases and data types to store and manipulate data. In many database driven applications, a relational database may be created to store various data, and calls may be made to the database to store and retrieve data. Similarly, the same applications may store and manipulate data in memory objects, which may contain data retrieved from the database.

In many computer programming systems, such applications may be created by separately creating the databases and memory objects. Such effort may be duplicative in some cases and may be tedious and error prone.

### SUMMARY

An application programming interface may alter the inferences made by a set of conventions that may infer database objects from memory objects in an application. The changes or overrides to the inferences may be applied when the application is executed and may cause the database objects to be created or organized in a different manner than when the original inferences were used. A configuration database may store the inferences and overrides, and may be referenced when the conventions are applied. The configuration database may be incrementally updated so that any changes or overrides are persisted to the next version of an application.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram of an embodiment showing a system for using conventions in code development.

FIG. 2 is a diagram of an embodiment showing a sequence for using conventions in code development.

FIG. 3 is a flowchart of an embodiment showing a method for using conventions and overrides in code development.

### DETAILED DESCRIPTION

A programming environment may infer database objects from memory objects and memory objects from database objects. The inferences may allow a programmer to define objects in one form and use the objects in another form, and the inferences may be stored in a configuration database.

The inferences may be made from a set of conventions that interpret the various objects to create a corresponding object. The set of conventions may be expanded and modified to address different naming conventions, data type interpretations, or other situations. The conventions may produce an entity data model or object-relational mapping of the various objects in a set of code.

The conventions may infer many different items from the source code. These inferences may or may not be what a programmer is expecting. When the conventions infer something that is unexpected or unwanted, the programmer may override or change the inference by using an application programming interface (API).

The overrides or changes may be used to change single instances of a convention. In many cases, a convention may be invoked multiple times when applied to the code, and the programmer may be able to change the effects of the convention in one case but not another.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

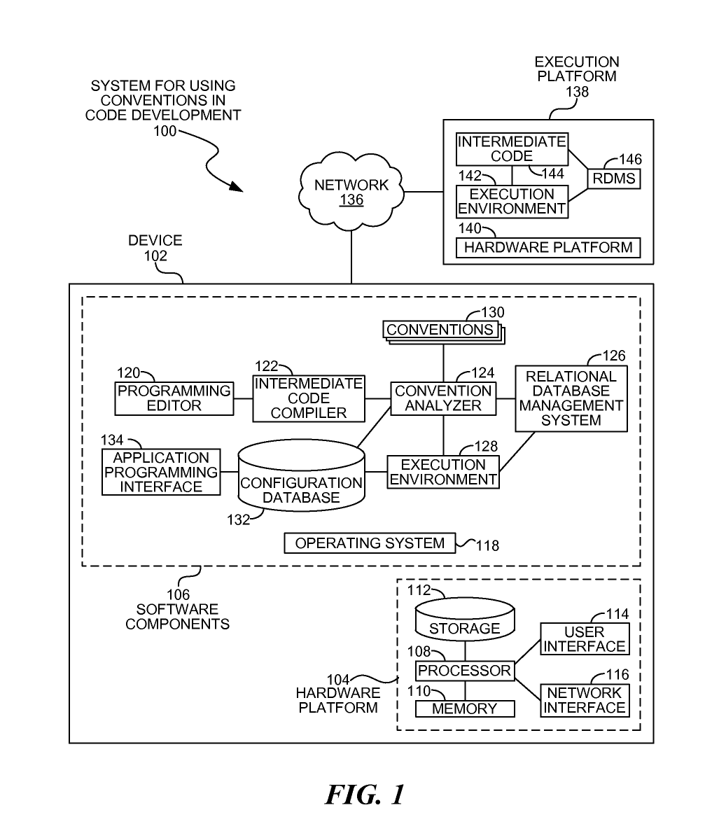

FIG. 1 is a diagram of an embodiment 100, showing a device 102 that may be used to create executable application code that includes database information derived from application code.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 illustrates an environment in which database objects may be inferred or derived from application code using a set of conventions. The inferences may be overridden by modifying a configuration database that stores the various inferences.

The conventions may define rules by which memory objects defined in application source code may be used to create a database, which may be used as part of the application. The conventions may create an entity data model that may be an object-relational mapping between memory objects with complex data types and database objects with scalar data types. In many cases, the entity data model may include relationships, constraints, or other metadata.

The conventions may be a set of rules that interprets memory objects and infers a database structure based on the memory objects. The conventions may infer structure based on naming conventions or other identifiers for the memory objects.

The inferences may be stored in a configuration database that may be modified by the programmer. When an inference is not what the programming anticipated, the inference may be overridden by either explicitly defining the item in the program code or by using an application programming interface to override the inference.

When the conventions are being applied to the application code, any overrides or changes to the configuration database may take precedence over the convention. In many cases, an override may be put in place for a single instance of a convention. In such cases, the convention may remain as an executable convention that may be used in several situations, but in the situation in which the override is defined, the convention may not be executed and the override value used instead. In many cases, the override value may be used as input to another convention to further infer configuration information.

The overrides may be stored in a configuration database. The configuration database may contain all overrides, inferences, or other information that may be used by the conventions to create an object relational model from the source code. In many embodiments, the object relational model may then be used to create a database that represents the objects defined in the application code, and the database may be queried or accessed by the application code during execution.

The configuration database may be any type of mechanism to store data. In some cases, the configuration database may be implemented by statements in the source code of an application. The overrides may be persisted in the source code and referenced by the conventions when the conventions are executed. At runtime, the overrides may be loaded into volatile memory and accessed as the conventions are executed.

In a simple example of how the conventions may operate, a set of memory objects may be defined using “ID” or “Key” names. These objects may be identified by the conventions as indexes or keys for a database, and may be further inferred to be primary keys or foreign keys, depending on the context. The conventions may create the corresponding keys in a database and establish a corresponding object relational model element.

If the conventions are executed, the conventions may identify an object “ProductID” as a primary key for a table. However, the programmer may have intended an object named “SerialNumber” to be the primary key for the table. In such a case, the programmer may define the primary key to be “SerialNumber” by either expressly defining it as such in the source code or by applying an override for the inference in the configuration database.

The conventions may be executed on source code or intermediate code. Source code may refer to code written by a developer, while intermediate code may be source code that has been compiled. Intermediate code may be further compiled at runtime into machine code that is executable. Intermediate code may include mappings or other metadata that relate back to names used in the source code.

When conventions are executed against intermediate code, the conventions may use various syntactic or semantic information. The additional information may be embedded in the intermediate code or contained in a separate location or file.

In some embodiments, the conventions may create a new database based on classes or other memory objects defined in source code. Such embodiments may infer database tables from the memory objects and create those tables. The database may be accessed through the source code or through another application that performs queries against the database.

In some embodiments, the conventions may evaluate an existing database and create a mapping from the existing database schema to memory objects defined in the source code. In some embodiments, the first time an application may be compiled may generate a new database and subsequent modifications and compilations may update the mapping.

The system of embodiment 100 is illustrated as being contained in a single device 102. The device 102 may have a hardware platform 104 and software components 106. The device 102 may represent a developer's workstation where the developer may create, compile, test, and edit code on a single device. Other embodiments may deploy one or more components on different hardware platforms.

The device 102 may represent a user workstation or other powerful, dedicated computer system that may be used to develop and test code. In some embodiments, however, the device 102 may be any type of computing device, such as a personal computer, game console, cellular telephone, netbook computer, or other computing device.

The hardware platform 104 may include a processor 108, random access memory 110, and nonvolatile storage 112. The processor 108 may be a single microprocessor, multi-core processor, or a group of processors. The random access memory 110 may store executable code as well as data that may be immediately accessible to the processor 108, while the nonvolatile storage 112 may store executable code and data in a persistent state.

The hardware platform 104 may include a user interface 114. The user interface 114 may include monitors, keyboards, pointing devices, and other input and output devices for a user. The user input devices may include keyboards, pointing devices such as mice or styli, audio and video input or output devices, or other peripherals. In some embodiments, the user input devices may include ports through which a user may attach various peripheral devices. Examples of such ports may be Firewire, Universal Serial Bus (USB), or other hardwired connections. Other examples may include wireless ports such as Bluetooth, WiFi, or other connection types.

The hardware platform 104 may also include a network interface 116. The network interface 116 may include hardwired and wireless interfaces through which the device 102 may communicate with other devices.

The software components 106 may include an operating system 118 on which various applications may execute.

A programming editor 120 may be an application in which a developer may write source code. Many programming editors may include compilers, debugging systems, and other tools that help a developer write and test code.

After generating source code with the programming editor 120, an intermediate code compiler 122 may generate intermediate code.

A convention analyzer 124 may analyze the intermediate code to identify database objects that can be inferred from the code. The convention analyzer 124 may create a database in a relational database management system 126. In some cases, the convention analyzer 124 may use an existing database to modify the database or to create a mapping between the memory objects in the intermediate code and the schema of the database.

The system may include an execution environment 128 in which the compiled code may be executed. In some cases, the execution environment 128 may be a debugging environment that may be instrumented to monitor various items during execution. In other cases, the execution environment 128 may be a production execution environment in which the code may be executed in a production mode, as opposed to a debug mode.

The convention analyzer 124 may operate with a set of conventions 130 that may be overridden using an application programming interface 134 and a configuration database 132. The application programming interface 134 may be a mechanism whereby the programmer may make changes to the inferences created by conventions by creating overrides for specific conventions or instances of conventions. The application programming interface 134 may be accessed through the source code of an application or by another application.

In some embodiments, the device 102 may be used for code development while other devices may be used for executing the finished code. Such embodiments may be execution platforms 138 that may be accessed over a network 136. In some embodiments, the execution platforms 138 may have the executable code and databases transmitted via some software medium, such as an optical or magnetic disk, solid state memory device, or other storage medium.

The execution platform 138 may contain many of the same items as the device 102, but may not contain development level components that may be used for writing, testing, and debugging code. The execution platform 138 may have a hardware platform 140 that may be similar to the hardware platform 104 containing a processor and other components.

The hardware platform 140 may be any type of computing platform. The hardware platform 140 may be a server computer, desktop computer, laptop computer, game console, mobile telephone, portable personal digital computer, media player, or any other device with a processor.

The execution platform 138 may include an execution environment 142 that executes intermediate code 144 and execute with a relational database management system 146. In some embodiments, the execution environment 142 may execute machine code and not intermediate code.

In some embodiments, the relational database management system 146 may be a service accessed over the network 136 and provided by another device, which could be a cloud based database system.

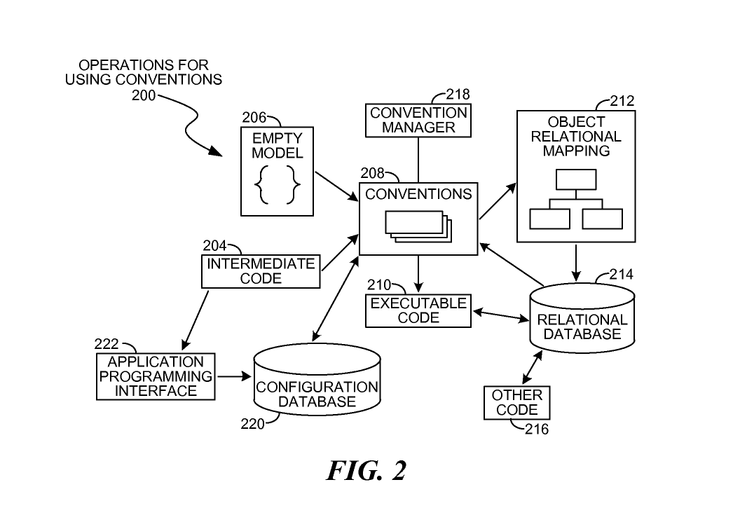

FIG. 2 is a diagram representation of an embodiment 200 illustrating various components and operations performed when an application is created. Embodiment 200 is a conceptual illustration showing a process for creating an application where a data model is inferred from code to create a database, which can be used by the application or another application.

In embodiment 200, a developer may create an application that contains intermediate code 204 and an empty data model 206. At such a stage in development, the application may contain source code or compiled intermediate code but no database or data model.

A set of conventions 208 may be executed against the intermediate code 204 that may infer an object relational mapping 212. When the conventions 208 are executed against the intermediate code 204, a configuration database 220 may be consulted. The configuration database 220 may include overrides that may be used in place of an inferred value or item from a convention. The overrides may be created through an application programming interface 222 that may receive a value with which to override a convention, then may store the override value in the configuration database 220. When the set of conventions 208 are executed against the intermediate code 204, the overrides in the configuration database 220 may take precedence over an inferred value by a convention.

The object relational mapping 212 represents a populated version of the entity data model 206 as processed by the conventions 208. The object relational mapping 212 may be a representation of memory objects that may be used to generate a relational database 214.

After processing the source code or intermediate code with the conventions 208, executable code 210 may be created. The executable code 210 may access the relational database 214. In some embodiments, other code 216 may access the relational database 214.

The conventions 208 may create the object relational mapping 212 according to standardized conventions, which may define a database, including the database name, tables in relational database, the table names, rows in the tables, data types of the database elements, primary and foreign keys in the database, relationships within the database, and other components of the database.

In some embodiments, the object relational mapping 212 may be defined using an XML definition. Some embodiments may be able to display a graphical representation of the object relational mapping 212.

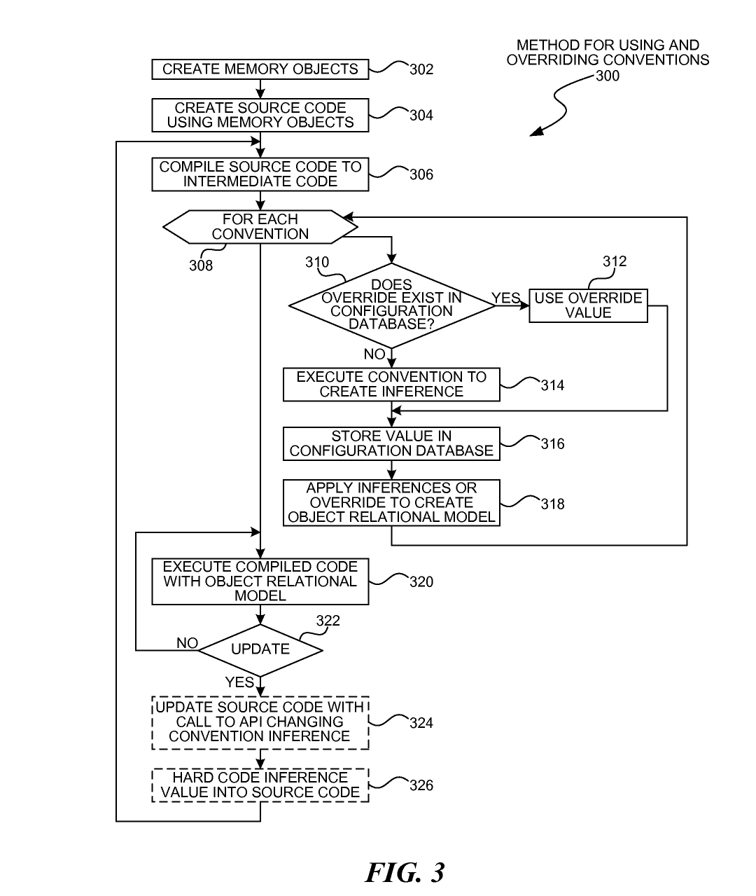

FIG. 3 is a flowchart illustration of an embodiment 300 showing a method for using conventions to generate an object relational model and corresponding database. Embodiment 300 is a simplified example of a method that may be performed by a code development system that generates object relational models from source code.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 300 is a simplified example of a method that may be performed during the development of computer executable code. A set of conventions may be used to analyze the code and infer an object relational model. From the object relational model, a database may be created that may be accessed by the executable code or by another application.

A configuration database may be used to store overrides for conventions. The configuration database may be referenced each time a convention is referenced to determine whether or not an override exists. If an override exists, the system may use the value defined in the configuration database rather than an inferred value from the convention.

After processing the application code with the conventions and executing the application, a programmer may make changes to the configuration database and re-apply the conventions with the changes applied.

In many cases, the configuration database may store all previous changes to the configuration database. In such embodiments, the programmer may make incremental changes without having to redefine all previously defined overrides.

In block 302, a developer may create memory objects and may create source code using the memory objects in block 304. The memory object definitions may be classes, variables, parameters, or other data storage devices within the source code being used to develop an application.

The source code may be compiled into intermediate code in block 306. In some embodiments, the source code may be analyzed by the conventions prior to compilation. In such embodiments, the conventions may analyze the source code directly rather than intermediate code.

Analyzing intermediate code may be useful in embodiments where several different languages may be available in a programming environment. In some cases, analysis of intermediate code may be simpler than analysis of source code, since intermediate code may be optimized and made more consistent than source code.

The conventions may be applied to the intermediate code in block 308. The configuration database may be queried and if an override exists in block 310, the value provided in the override may be used in block 312 and the process may continue to block 316.

If no override exists for the convention, the convention may be executed against the code to create an inference in block 314. The value of the inference may be stored in block 316. The inference or override value may be used in block 318 to create or modify an object relational model.

After processing all of the conventions in block 308, the compiled code may be executed with the object relational model in block 320. In many embodiments, the object relational model may be used to create a relational database that may be accessed and queried by the application code.

The application may execute until an update is to be performed in block 322.

If an update is to be performed, the programmer may change the outcome of a convention in two ways. In a first way, the source code of the application may be updated with a call to the application programming interface for the configuration database in block 324.

In a second way to change the outcome of a convention, the programmer may explicitly define the correct inferred value into the source code in block 326.

In the first method, a convention may be overridden by changes in the configuration database. In the second method, the inferred value may be expressly stated so that the convention may not be invoked.

After updating the configuration database or the source code, the process may return to block 306 to re-apply the conventions and execute the application.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A system comprising:
a first set of data types defining data objects within a programming language for a first application;
a set of conventions that infer a database based on said data objects and said data types, said database being a relational database comprising a plurality of tables and relationships between said tables;
a relational database system comprising said database, said set of conventions comprising executable code that creates said database as inferred from said data objects and said data types; and
an application programming interface that receives input for a first convention, said input comprising a user-defined inference for a first instance of a first convention, said first instance of said first convention being not executed when inferring said data objects from said data types.

2. The system of claim 1 further comprising:
a configuration database comprising inferences from said set of conventions, said configuration database further comprising said input for said first convention.

3. The system of claim 2, said input for said first convention overriding said first instance of said first convention.

4. The system of claim 3, said input for said first convention not overriding a second instance of said first convention.

5. The system of claim 3, said input for said first convention also overriding a second instance of said first convention.

6. The system of claim 1, said input defining a property for a first class, said first convention inferring said property.

7. The system of claim 1, said input identifying a first database key, said first convention inferring a second database key.

8. The system of claim 7, said database being created with said first database key and not said second database key.

9. The system of claim 8, said first database key being used to map a relationship between two objects in said database.

10. A method comprising:
creating a first application source code using a first programming language and comprising data objects defined using data types;
analyzing said first application using a set of conventions and creating a first relational database based on said data objects and said data types, said first relational database operating on a relational database system, said set of conventions inferring a plurality of inferences from said first application source code to create said first relational database;
storing said plurality of inferences in a configuration database;
executing said first application such that said first application may make a call to said first relational database to access data contained in a first data object of said data objects;
changing a first inference in said configuration database;
analyzing said first application using said set of conventions and said configuration database and creating a second relational database; and
executing said first application with said second relational database.

11. The method of claim 10, said first inference being changed by calling an application programming interface.

12. The method of claim 11, said application programming interface being called from said first application source code.

13. The method of claim 11, said application programming interface being called from outside said first application source code.

14. The method of claim 10, said first inference being a first property for an object, said object comprising at least a second property being inferred by at least one convention.

15. The method of claim 10 further comprising:
updating said first application to create a second application; and
executing said second application with said second relational database.

16. A system comprising:
a programming environment in which application code may be created and edited;
a set of conventions being executable code that infer a database based on data objects and data types, said database being a relational database;
a configuration database storing inferences created by said set of conventions;
an application programming interface that receives input to create overrides for said inferences in said configuration database;
an execution environment that:
receives a first application code defining data objects for a first application;
executes said set of conventions against said first application code, using said overrides in said configuration database in place of at least one of said conventions to create a first relational database; and
executes said first application code with said first relational database.

17. The system of claim 16, said overrides being added to said configuration database after executing said first application code a first time.

18. The system of claim 16, a first override overriding a first instance of a first convention.

19. The system of claim 18, said first override not overriding a second instance of said first convention.

20. The system of claim 19, said first override being stored in said configuration database.
